(19) United States
(12) Patent Application Publication
(10) Pub. No.: US 2024/0222729 A1
(43) Pub. Date: Jul. 4, 2024

(54) BATTERY CORE UNIT, BATTERY, AND VEHICLE

(71) Applicant: BYD COMPANY LIMITED, SHENZHEN (CN)

(72) Inventors: Yongming GUO, Shenzhen (CN); Xiaoqiang LANG, Shenzhen (CN); Wei CHEN, Shenzhen (CN); Yanfei ZHOU, Shenzhen (CN); Yaolei CHEN, Shenzhen (CN)

(21) Appl. No.: 18/609,749

(22) Filed: Mar. 19, 2024

Related U.S. Application Data
(63) Continuation of application No. PCT/CN2022/132611, filed on Nov. 17, 2022.

(30) Foreign Application Priority Data
Nov. 24, 2021 (CN) 202122903216.7

(51) Int. Cl. H01M 10/48; H01M 50/211; H01M 50/509

(52) U.S. Cl. CPC H01M 10/482; H01M 50/211; H01M 50/509

(57) ABSTRACT

A battery core unit includes a battery core string and a sampling structure. The battery core string includes multiple battery core groups and at least one fixing support, the battery core groups are connected and disposed along a first direction, and two adjacent battery core groups are connected via a fixing support of the at least one fixing support. The sampling structure is electrically connected with the battery core groups, the sampling structure includes a notch, and the notch includes a limiting strip. The fixing support includes a first protrusion and a second protrusion, the first protrusion and the second protrusion are located in the notch and disposed spaced apart to form a spacing region, and the limiting strip is fitted in the spacing region.

### CROSS-REFERENCE TO RELATED APPLICATIONS

The application is a continuation application of International Patent Application No. PCT/CN2022/132611 filed on Nov. 17, 2022, which is based on and claims priority to and benefits of Chinese patent application Ser. No. 20/212,2903216.7 filed on Nov. 24, 2021. The entire content of all of the above-referenced applications is incorporated herein by reference.

### FIELD

The present disclosure relates to the technical field of batteries, and more particularly, to a battery core unit, a battery, and a vehicle.

### BACKGROUND

In related arts, multiple battery cores connected in series are arranged in a battery to increase an output voltage of the battery, and a sampling wire harness is arranged inside the battery to collect signals of voltage and/or temperature and the like of each battery core, so as to acquire an operation state of each battery core. However, the sampling wire harness is not fixed, and consequently, when the battery vibrates for a long term, the sampling wire harness shakes, causing a joint of the sampling wire harness and the battery core likely to become loose. As a result, related information of the battery core cannot be collected in time.

### SUMMARY

The present disclosure solves at least one of technical problems existing in the related arts. Accordingly, the present disclosure provides a battery core unit, a battery, and a vehicle, facilitating improvement of connection reliability of a sampling structure and battery cores.

According to a first aspect, the present disclosure provides a battery core unit. The battery core unit includes: a battery core string and a sampling structure.

The battery core string includes multiple battery core groups and at least one fixing support, the battery core groups are connected and disposed along a first direction, and two adjacent battery core groups are connected via a fixing support of the at least one fixing support.

The sampling structure is electrically connected with the battery core groups, the sampling structure includes a notch, and the notch includes a limiting strip. The fixing support includes a first protrusion and a second protrusion, the first protrusion and the second protrusion are located in the notch and disposed spaced apart to form a spacing region, and the limiting strip is fitted in the spacing region.

According to the battery core unit provided by this embodiment of the present disclosure, the sampling structure is provided with the notches. Each of the notches is internally provided with the limiting strip. The fixing support is provided with the first protrusions and the second protrusions. The first protrusions and the second protrusions are arranged/disposed spaced apart to form the spacing regions. The limiting strips are fitted within the spacing regions, such that the sampling structure can be arranged/disposed on the fixing support through the limiting strips, so as to reduce shaking of the sampling structure, which is beneficial to improve connection reliability of the sampling structure and battery cores.

In some embodiments, an opening of the notch is located on a top surface of the sampling structure, the opening is extended along the first direction, the first protrusions and the second protrusions are disposed spaced apart along the first direction, and two opposite inner walls of the notch along a second direction are connected by the limiting strip.

In some embodiments, the sampling structure includes multiple collection terminals, each of the collection terminals is electrically connected with a corresponding battery core group, and the collection terminals include a first collection terminal, second collection terminals, and third collection terminals. The first collection terminal and the second collection terminals are disposed at two opposite ends of the battery core string along the first direction, the third collection terminals are located between the first collection terminal and the second collection terminals, and the third collection terminals are disposed on the top surface of the sampling structure and located on the notch.

In some embodiments, the battery core unit includes at least two battery core strings. The at least two battery core strings are disposed along the second direction. Each of the at least two battery core strings has a first end and a second end opposite to each other along the first direction. The at least two battery core strings include a first battery core string and a second battery core string, and the first battery core string and the second battery core string are connected through two first battery core groups respectively located at the first ends of the first battery core string and the second battery core string.

Each of the first battery core string and the second battery core string includes M battery core groups disposed along the first direction, and M is an integer greater than or equal to 2. The sampling structure includes 2M+1 collection terminals that include one first collection terminal, two second collection terminals, and 2M−2 third collection terminals. The first collection terminal is disposed at the first ends of the first battery core string and the second battery core string, the two second collection terminals are respectively disposed at the second ends of the first battery core string and the second battery core string, and the two second collection terminals and the 2M−2 third collection terminals are extended in the second direction.

The first battery core groups respectively located at the first ends are electrically connected with the first collection terminal, and second battery core groups respectively located at the second ends are respectively electrically connected with the two second collection terminals. The 2M−2 third collection terminals include M−1 pairs of third collection terminals, each of the M−1 pairs of third collection terminals includes two third collection terminals, and the two third collection terminals are located between two adjacent battery core groups respectively of the first battery core string and the second battery core string and are electrically connected with the two adjacent battery core groups of the first battery core string and the second battery core string.

In some embodiments, the sampling structure is bonded and fixed to the fixing support.

In some embodiments, the two adjacent battery core groups are connected through a conductive connection member, and the fixing support is disposed between the two adjacent battery core groups and is configured to fix the conductive connection member.

Each of the battery core groups includes at least two battery cores connected in parallel, each of the at least two battery cores has a positive tab and a negative tab, and the positive tab and the negative tab are disposed at two opposite ends of each of the at least two battery cores along the first direction.

A positive tab and a negative tab of the two adjacent battery cores are connected through the conductive connection members.

In some embodiments, the fixing support includes two first supports oppositely disposed along the first direction.

The conductive connection member includes a first conductive sheet and a second conductive sheet respectively fixed to the two first supports.

The positive tabs of the adjacent battery core penetrates through a first one of the two first supports and is connected with the first conductive sheet, and the negative tab of the adjacent battery core penetrates through a second one of the first supports and is connected with the second conductive sheet.

In some embodiments, each of the conductive sheets includes a body portion and a first bending portion.

The body portions of the conductive sheets are respectively located on two opposite sides of the two first supports, and the body portions are configured to be electrically connected with the positive tab or the negative tab of the adjacent battery cores.

The first bending portion is disposed at one end of the body portion close to the sampling structure, and is configured to be electrically connected with the sampling structure.

In some embodiments, each of the conductive sheets further includes a second bending portion, the second bending portion is disposed on one side of the body portion opposite to the first bending portion, an avoidance opening is defined by the second bending portion and the body portion, and the avoidance opening is configured to accommodate the positive tab or the negative tab of the adjacent battery cores.

The conductive connection member further includes a first connection sheet. The second bending portions of the conductive sheets are electrically connected through the first connection sheet.

In some embodiments, the battery core unit includes at least two battery core strings. The at least two battery core strings are disposed along the second direction, each of the at least two battery core strings has a first end and a second end opposite to each other along the first direction, the at least two battery core strings include a first battery core string and a second battery core string, and the first battery core string and the second battery core string are connected through two first battery core groups respectively located at the first ends.

Two adjacent battery core groups respectively in the first battery core string and the second battery core string correspond to the same first support, the conductive sheets are disposed on the first support and are spaced apart, and each of the conductive sheets is electrically connected with the corresponding battery core group.

In some embodiments, the first battery core string and the second battery core string are connected in series by the adjacent battery core groups respectively of the first battery core string and of the second battery core string.

According to a second aspect, the present disclosure further provides a battery, which includes a housing and a battery core unit according to any one of the above embodiments. The battery core unit is disposed in the housing.

According to a third aspect, the present disclosure further provides a vehicle, which includes a battery core unit according to any one of the above embodiments or a battery according to any one of the above embodiments.

According to the battery provided by the present disclosure, the sampling structure can be arranged/disposed on the fixing support through the limiting strips, so as to reduce shaking of the sampling structure, which is beneficial to improve connection reliability of the sampling structure and the battery cores.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible in the description of the embodiments made with reference to the following accompanying drawings.

FIG. 1 is a schematic diagram of a battery according to an embodiment of the present disclosure;

FIG. 2 is a schematic diagram of the battery in FIG. 1 without a housing;

FIG. 3 is a partial enlarged view of a position A in FIG. 2;

FIG. 4 is an exploded view of FIG. 2;

FIG. 5 is a partial enlarged view of a position B in FIG. 4;

FIG. 6 is a partial enlarged view of a position C in FIG. 4;

FIG. 7 is a schematic structural diagram of connection of two adjacent battery core groups in a same battery core string with first supports and conductive sheets;

FIG. 8 is an exploded view of FIG. 7;

FIG. 9 is an exploded view of a structure indicated by a square at a position D in FIG. 8;

FIG. 10 is an exploded view of a structure indicated by a square at a position E in FIG. 8;

FIG. 11 is a schematic diagram of a partial structure of a battery core unit, illustrating connection of a first battery core group, a second battery core group, a second connection sheet, and a second support; and

FIG. 12 is a schematic diagram of a vehicle according to an embodiment of the present disclosure.

### DESCRIPTIONS OF REFERENCE NUMERALS

2000—vehicle;

1000—battery;

100—battery core unit; 101—battery core string; 102—sampling structure; 103—battery core group; 1031—battery core; 1032—positive tab; 1033—negative tab; 104—fixing support; 106—notch; 107—limiting strip; 108—first protrusion; 109—second protrusion; 110—spacing region; 111—collection terminal; 112—first collection terminal; 113—second collection terminal; 114—third collection terminal; 115—first battery core string; 116—second battery core string; 117—conductive connection member; 118—first support; 119—conductive sheet; 1191—body portion; 1192—first bending portion; 1193—second bending portion; 120—first connection sheet; 121—first battery core group; 122—second battery core group; 123—second connection sheet; 1231—base body portion; 1232—extension portion; 124—second support; 25—third support; 126—third connection sheet; 127—first end; 128—second end; 129—first side; 130—second side; 131—avoidance opening; 132—third battery core group; 133—fourth battery core group; 134—through hole; and

200—housing.

### DETAILED DESCRIPTION

Embodiments of the present disclosure are described in detail below, and examples of the embodiments are shown in the accompanying drawings, where the same or similar elements or the elements having the same or similar functions are denoted by the same or similar reference numerals throughout the description. The embodiments described below with reference to the accompanying drawings are exemplary, are used only for explaining the present disclosure, and should not be construed as a limitation on the present disclosure.

In the description of the present disclosure, it should be understood that orientation or position relationships indicated by the terms such as “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “axial direction”, “radial direction”, and “circumferential direction” are based on orientation or position relationships shown in the accompanying drawings, to facilitate the description of the present disclosure and simplify the description only, rather than indicating or implying that the mentioned apparatus or element must have a particular orientation or must be constructed and operated in a particular orientation. Therefore, such terms should not be construed as limiting of the present disclosure.

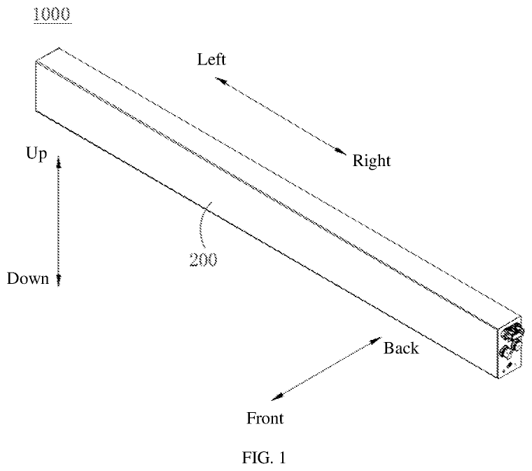

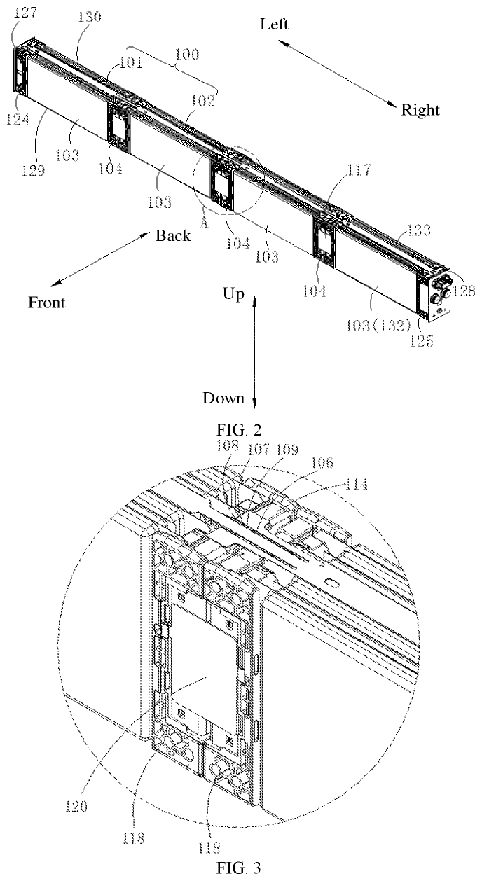

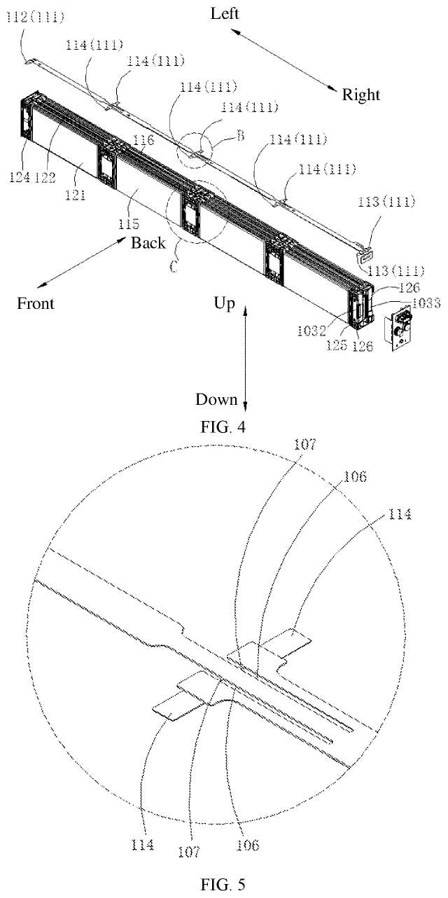

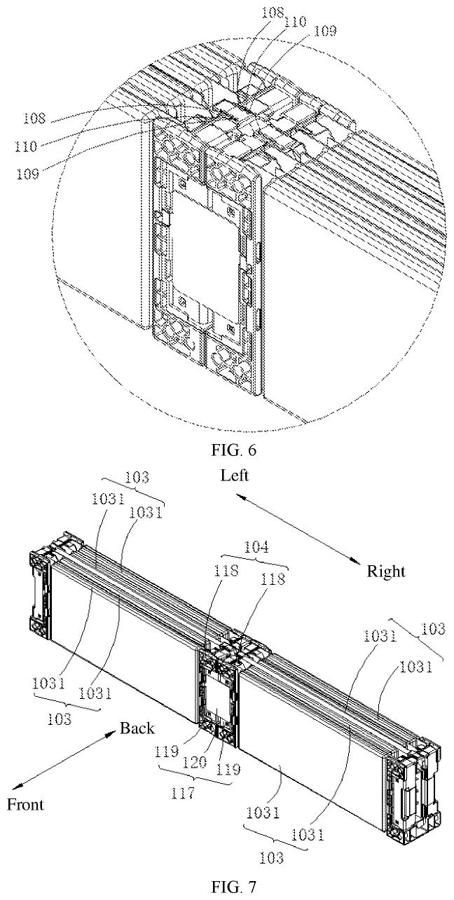

As shown in FIG. 1 to FIG. 6, the present disclosure provides a battery core unit 100, which includes a battery core string 101 and a sampling structure 102. The battery core string 101 includes multiple battery core groups 103 and at least one fixing support 104. The multiple battery core groups 103 are arranged/disposed along a first direction and connected in series, and an electrical connection position of any two adjacent battery core groups 103 is provided with the fixing support 104. The sampling structure 102 is electrically connected with the multiple battery core groups 103. The sampling structure 102 is provided with notches 106. Each of the notches 106 is internally provided with a limiting strip 107. The limiting strip 107 is connected with an inner wall of the notch 106. The fixing support 104 is provided with first protrusions 108 and second protrusions 109. The first protrusions 108 and the second protrusions 109 are located in the notches 106. The first protrusions 108 and the second protrusions 109 are arranged spaced apart to form spacing regions 110. The limiting strips 107 are arranged/disposed and fitted within the spacing regions 110, such as by a limiting fit. The first direction may be a left-right direction in FIG. 2, and the first direction may be consistent to a length direction of the battery core string 101 or a battery 1000. In addition, the battery core group 103 includes at least one battery core 1031. When the battery core group 103 includes multiple battery cores 1031, the battery cores 1031 are connected in parallel. The battery core 1031 maybe a bare battery core, or a pouch battery core.

It should be noted that the limiting fit may be understand in a way that two opposite sides of the limiting strip 107 directly or indirectly abut against the first protrusion 108 and the second protrusion 109, such that the limiting strip 107 is arranged and fitted within the spacing region 110. According to the battery core unit 100 provided by the present disclosure, the sampling structure 102 is provided with the notches 106. Each of the notches 106 is internally provided with the limiting strip 107. The fixing support 104 is provided with the first protrusions 108 and the second protrusions 109. The first protrusions 108 and the second protrusions 109 are arranged/disposed and spaced apart to form the spacing regions 110. The limiting strips 107 are arranged and fitted within the spacing regions 110, such that the sampling structure 102 can be arranged on the fixing support 104 through the limiting strips 107, so as to reduce shaking of the sampling structure 102, which is beneficial to improve connection reliability of the sampling structure 102 and the battery cores 1031.

In some embodiments, the fixing support 104, the first protrusions 108, and the second protrusions 109 may be integrated as a single member, by integrated injection molding.

In some embodiments, the sampling structure 102 may be a flexible printed circuit board or a flexible flat cable.

In some embodiments, as shown in FIG. 4 to FIG. 6, an opening of the notch 106 is located in one side of the sampling structure 102 along the first direction. The first protrusions 108 and the second protrusions 109 are distributed and spaced apart along the first direction. Two opposite inner walls of the notch 106 along a second direction are connected with the limiting strip 107. Therefore, the problem about deformation of an opening side of the notch 106 can be ameliorated by the limiting strip 107, so as to keep the shape of the notch 106 as much as possible. The second direction may be a front-back direction in FIG. 4, and the second direction may be consistent to a thickness direction of the battery core string 101 or the battery 1000.

In some embodiments, as shown in FIG. 2 to FIG. 6, the sampling structure 102 is provided with multiple collection terminals 111, and each of the collection terminals 111 is electrically connected with the corresponding battery core group 103. The multiple collection terminals 111 are respectively a first collection terminal 112, second collection terminals 113, and third collection terminals 114. The first collection terminal 112 and the second collection terminals 113 are distributed at two opposite ends of the battery core string 101 along the first direction, and the third collection terminals 114 are located between the first collection terminal 112 and the second collection terminals 113. The third collection terminals 114 are arranged/disposed on a top surface of the sampling structure 102 and located on one side of the notch 106. This configuration can facilitate connection of the third collection terminals 114 and the battery core group 103. In addition, the problem that the opening of the notch 106 is enlarged by pulling during the connection of the third collection terminals 114 and the battery core group 103 can be ameliorated by the limiting strip 107, so as to improve connection reliability of the third collection terminals 114 and the battery core group 103.

In some embodiments, as shown in FIG. 2 and FIG. 4, the battery core unit 100 includes at least two battery core strings 101. The at least two battery core strings 101 are arranged/disposed along the second direction, and each of the battery core strings 101 has a first end 127 and a second end 128 opposite to each other along the first direction. The at least two battery core strings 101 include a first battery core string 115 and a second battery core string 116. The first battery core string 115 and the second battery core string 116 are connected in series through two battery core groups 103 respectively located at the first ends 127. Each of the first battery core string 115 and the second battery core string 116 includes M battery core groups 103 arranged/disposed along the first direction, and M is an integer greater than or equal to 2. 2M+1 collection terminals 111, including one first collection terminal 112, two second collection terminals 113, and 2M−2 third collection terminals 114, are disposed. The first collection terminal 112 is arranged/disposed at the first end 127 of the battery core string 101, and the two second collection terminals 113 are arranged/disposed at the second end 128 of the battery core string 101. The sampling structure 102 has a first side 129 and a second side 130 opposite to each other along the second direction. The two second collection terminals 113 and the 2M−2 third collection terminals 114 are evenly distributed on the first side 129 and the second side 130 of the sampling structure 102 respectively. Two battery core groups 103 located at the respective first ends 127 of the first battery core string 115 and the second battery core string 116 are both electrically connected with the first collection terminal 112. Two battery core groups 103 located at the respective second ends 128 of the first battery core string 115 and the second battery core string 116 are electrically connected with the two second collection terminals 113 in a one-to-one correspondence manner. The M−1 third collection terminals 114 are located on each side of the sampling structure 102. Each of the M−1 third collection terminals 114 is arranged/disposed between two adjacent battery core groups 103, and is electrically connected with the two adjacent battery core groups 103.

As shown in FIG. 2 and FIG. 4, the first battery core string 115 and the second battery core string 116 are arranged/disposed along a direction from front to back. Each of the first battery core string 115 and the second battery core string 116 includes four battery core groups 103 arranged along a direction from left to right. Nine collection terminals 111 are arranged, including one first collection terminal 112, two second collection terminals 113, and six third collection terminals 114. The two second collection terminals 113 and the six third collection terminals 114 are evenly distributed on the first side 129 and the second side 130 of the sampling structure 102 respectively. Two battery core groups 103 located at the leftmost ends of the first battery core string 115 and the second battery core string 116 are electrically connected with the first collection terminal 112. Two battery core groups 103 located at the rightmost ends of the first battery core string 115 and the second battery core string 116 are electrically connected with the two second collection terminals 113 in a one-to-one correspondence manner. Each of the three third collection terminals 114 located on a same side (e.g., the first side 129) of the sampling structure 102 is arranged between the two adjacent battery core groups 103, and is electrically connected with the two adjacent battery core groups 103. That is, along the direction from left to right, the first of the three third collection terminals 114 is located between the first battery core group 103 and the second battery core group 103, and is electrically connected with the two battery core groups 103; the second of the three third collection terminals 114 is located between the second battery core group 103 and the third battery core group 103, and is electrically connected with the two battery core groups 103; and the third of the three third collection terminals 114 is located between the third battery core group 103 and the fourth battery core group 103, and is electrically connected with the two battery core groups 103. A connection manner of the three third collection terminals 114 located on the second side 130 of the sampling structure 102 and the battery core groups 103 is similar to the connection manner of the three third collection terminals 114 located on the first side 129 of the sampling structure 102 and the battery core groups 103, which is not repeated herein. In addition, the number of the battery core groups 103 included in the first battery core string 115 and the second battery core string 116 can be set according to actual needs, for example, two or three.

It should be noted that the number of the collection terminals 111 can be set according to actual needs, which is not enumerated herein. For example, in some embodiments, it may also be that: 2M+2 collection terminals 111, including two first collection terminals 112, two second collection terminals 113, and 2M−2 third collection terminals 114, are disposed, where the two battery core groups 103 located at the respective first ends 127 of the first battery core string 115 and the second battery core string 116 are electrically connected with the two first collection terminals 112 in a one-to-one correspondence manner.

In some embodiments, the battery core unit 100 may also include one battery core string 101. The battery core string 101 has the first end 127 and the second end 128 opposite to each other along the first direction. The first collection terminal 112 is located at the first end 127 of the battery core string 101, and the second collection terminal 113 is located at the second end 128 of the battery core string 101. The battery core string 101 includes N battery core groups 103 arranged along the first direction, where N is an integer greater than or equal to 2. N+1 collection terminals 111, including one first collection terminal 112, one second collection terminal 113, and N−1 third collection terminals 114, are disposed. The first collection terminal 112 is electrically connected with the battery core group 103 located at the first end 127 of the battery core string 101. The second collection terminal 113 is electrically connected with the battery core group 103 located at the second end 128 of the battery core string 101. Each of the N−1 third collection terminals 114 is arranged between the two adjacent battery core groups 103, and is electrically connected with the two adjacent battery core groups 103. For example, the battery core string 101 includes four battery core groups 103 arranged along the direction from left to right, and five collection terminals 111, including one first collection terminal 112, one second collection terminal 113, and three third collection terminals 114, are disposed. The first collection terminal 112 is electrically connected with the battery core group 103 located at the leftmost end, and the second collection terminal 113 is electrically connected with the battery core group 103 located at the rightmost end. Along the direction from left to right, each of the three third collection terminals 114 is arranged between the two adjacent battery core groups 103, and is electrically connected with the two adjacent battery core groups 103. It should be noted that the number of the collection terminals 111 can be set according to actual needs. For example, in some embodiments, it may also be that: N+2 collection terminals 111, including one first collection terminal 112, one second collection terminal 113, and N third collection terminals 114, are arranged. Two third collection terminals 114 are electrically connected with two adjacent battery core groups 103 in a one-to-one correspondence manner.

In some embodiments, as shown in FIG. 4 to FIG. 6, two notches 106 are arranged/disposed in the second direction, and two first protrusions 108 and two second protrusions 109 are arranged. The first protrusions 108 and the second protrusions 109 are arranged in the corresponding notches 106. Each of the notches 106 is internally provided with the limiting strip 107. The limiting strip 107 is arranged and fitted in the corresponding spacing region 110. Through such configuration, it is beneficial to reduce displacement of the sampling structure 102, and improve connection reliability of the sampling structure 102 and the battery core groups 103.

In some embodiments, the sampling structure 102 is bonded and fixed to the fixing support 104. Accordingly, the sampling structure 102 and the fixing support 104 can be fixedly connected, and therefore it is beneficial to reduce displacement of the sampling structure 102, and improve connection reliability of the sampling structure 102 and the battery core string 101. In an embodiment, one side (e.g., the bottom side) of the sampling structure 102 in a thickness direction is provided with a structural adhesive, and the sampling structure 102 is bonded and fixed to the fixing support 104 through the structural adhesive.

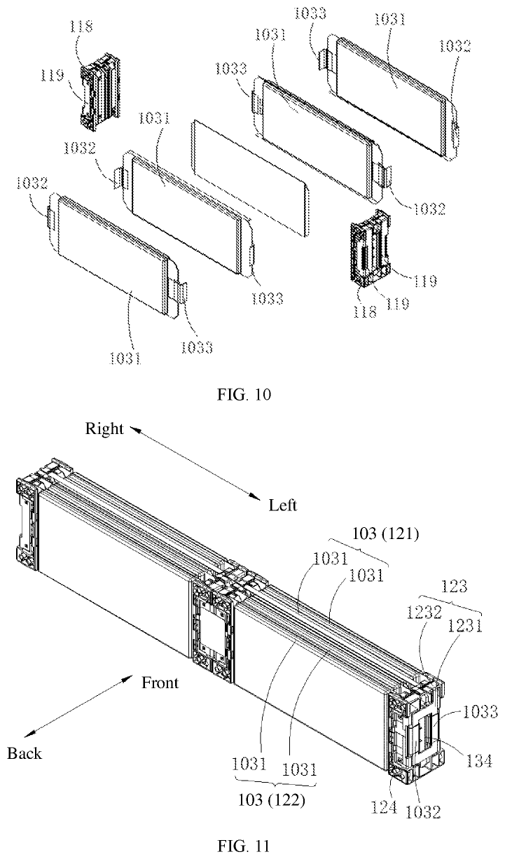

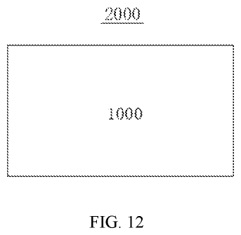

In some embodiments, as shown in FIG. 2 and FIG. 7 to FIG. 10, any two adjacent battery core groups 103 are connected through a conductive connection member 117. The fixing support 104 is arranged/disposed between any two adjacent battery core groups 103. The fixing support 104 is configured to fix the conductive connection member 117. The battery core group 103 includes at least two battery cores 1031 connected in parallel. The battery core 1031 has a positive tab 1032 and a negative tab 1033. The positive tab 1032 and the negative tab 1033 are distributed at two opposite ends of the battery core 1031 along the first direction. The positive tabs 1032 of the battery cores 1031 of one battery core group 103 of any two adjacent battery core groups 103 are connected with the negative tabs 1033 of the battery cores 1031 of another battery core group 103 (e.g., an adjacent battery core group) through the conductive connection members 117. As shown in FIG. 7 to FIG. 9, along the direction from left to right, each of the first battery core group 103 and the second battery core group 103 includes two battery cores connected in parallel. The positive tabs 1032 of the two battery cores 1031 included in the first battery core group 103 are connected with the negative tabs 1033 of the two battery cores 1031 included in the second battery core group 103 through the conductive connection members 117. In an embodiment, it may also be that the negative tabs 1033 of the two battery cores 1031 included in the first battery core group 103 are connected with the positive tabs 1032 of the two battery cores 1031 included in the second battery core group 103 through the conductive connection members 117. In addition, the battery core group 103 may further include three or more battery cores 1031 connected in parallel.

In some embodiments, as shown in FIG. 7 to FIG. 10, the fixing support 104 includes two first supports 118 oppositely arranged/disposed along the first direction. The conductive connection member 117 includes two electrically-connected conductive sheets 119. The two conductive sheets 119 are fixed to the two first supports 118 in a one-to-one correspondence manner. The positive tabs 1032 of the battery cores 1031 of one battery core groups 103 of any two adjacent battery core groups 103 penetrate through the corresponding first support 118 and are connected with the conductive sheet 119 on the first support 118. The negative tabs 1033 of the battery cores 1031 of the other battery core group 103 penetrate through the corresponding first support 118 and are connected with the conductive sheet 119 on the first support 118. As shown in FIG. 7 to FIG. 9, along the direction from left to right, the first conductive sheet 119 is fixed to the first of the two first supports 118, and the second conductive sheet 119 is fixed to the second of the two first supports 118. The positive tabs 1032 of the battery cores 1031 included in the first battery core group 103 penetrate through the first of the two first supports 118 and are connected with the conductive sheet 119 on the first support 118. The negative tabs 1033 of the battery cores 1031 included in the second battery core group 103 penetrate through the second of the two first supports 118 and are connected with the conductive sheet 119 on the first support 118. In an embodiment, it may also be that the negative tabs 1033 of the battery cores 1031 included in the first battery core group 103 penetrate through the first of the two first supports 118 and are connected with the conductive sheet 119 on the first support 118. The positive tabs 1032 of the battery cores 1031 included in the second battery core group 103 penetrate through the second of the two first supports 118 and are connected with the conductive sheet 119 on the first support 118.

In some embodiments, as shown in FIG. 4 to FIG. 8, the sampling structure 102 is arranged on one side of the battery core string 101 along a third direction. The conductive sheet 119 includes a body portion 1191 and a first bending portion 1192. The body portions 1191 of the two conductive sheets 119 are located on two opposite sides of the two first supports 118. The body portions 1191 are configured to be electrically connected with the positive tabs 1032 or the negative tabs 1033 of the battery cores 1031 of the corresponding battery core groups 103. The first bending portion 1192 is arranged/disposed at one end of the body portion 1191 close to the sampling structure 102, and the first bending portion 1192 is located on one side of the corresponding first support 118 along the third direction. The first bending portion 1192 is configured to be electrically connected with the sampling structure 102. In an embodiment, the first bending portion 1192 maybe configured to be connected with the third collection terminal 114. By disposing the first bending portion 1192 on one side of the first support 118 along the third direction, connection of the first bending portion 1192 and the sampling structure 102 is facilitated. The third direction may be an up-down direction in FIG. 4, and the third direction may be consistent to a width direction of the battery core string 101 or the battery 1000. In some embodiments, the first direction may also be consistent to the width direction of the battery core string 101 or the battery 1000, and the third direction may also be consistent to the length direction of the battery core string 101 or the battery 1000.

Further, the conductive sheet 119 further includes a second bending portion 1193. The second bending portion 1193 is arranged/disposed on one side of the body portion 1191 along the second direction, and the second bending portion 1193 is located on one side of the corresponding first support 118 along the second direction. An avoidance opening 131 is defined by the second bending portion 1193 and the body portion 1191 jointly, and the avoidance opening 131 is configured to accommodate the positive tab 1032 or the negative tab 1033 of at least one battery core 1031 of the corresponding battery core group 103. For example, the battery core group 103 includes two battery cores 1031 connected in parallel. The positive tabs 1032 or the negative tabs 1033 of the two battery cores 1031 are connected in parallel and may both extend out of the avoidance opening 131. In an embodiment, the positive tab 1032 of one battery core 1031 extends out of the avoidance opening 131, and the positive tab 1032 of the other battery core 1031 directly extends out of the first support 118. In an embodiment, the negative tab 1033 of one battery core 1031 extends out of the avoidance opening 131, and the negative tab 1033 of the other battery core 1031 directly extends out of the first support 118.

Further, the conductive connection member 117 further includes a first connection sheet 120. The second bending portions 1193 of the two conductive sheets 119 are electrically connected through the first connection sheet 120. By disposing the second bending portion 1193 on one side of the first support 118 along the second direction, connection of the first connection sheet 120 and the second bending portion 1193 is facilitated.

In some embodiments, the conductive sheet 119 is fixed to the first support 118 through snap fit. In an embodiment, one side of the first support 118 along the second direction is provided with a snap-fit fastener, and the conductive sheet 119 is provided with a snap hole. The snap-fit fastener is snapped into the snap hole to fix the conductive sheet 119 to the first support 118. In some embodiments, the conductive sheet 119 may also be fixed to the corresponding first support 118 in a threaded connection manner.

In some embodiments, as shown in FIG. 2 to FIG. 4, the battery core unit 100 includes at least two battery core strings 101. The at least two battery core strings 101 are arranged along the second direction. Each battery core string 101 has the first end 127 and the second end 128 opposite to each other along the first direction. The at least two battery core strings 101 include the first battery core string 115 and the second battery core string 116. The first battery core string 115 and the second battery core string 116 are connected in series through the two battery core groups 103 located at the respective first ends 127. In some embodiments, three or more battery core strings 101 may be arranged, that is, the number of the battery core strings 101 can be set according to actual needs.

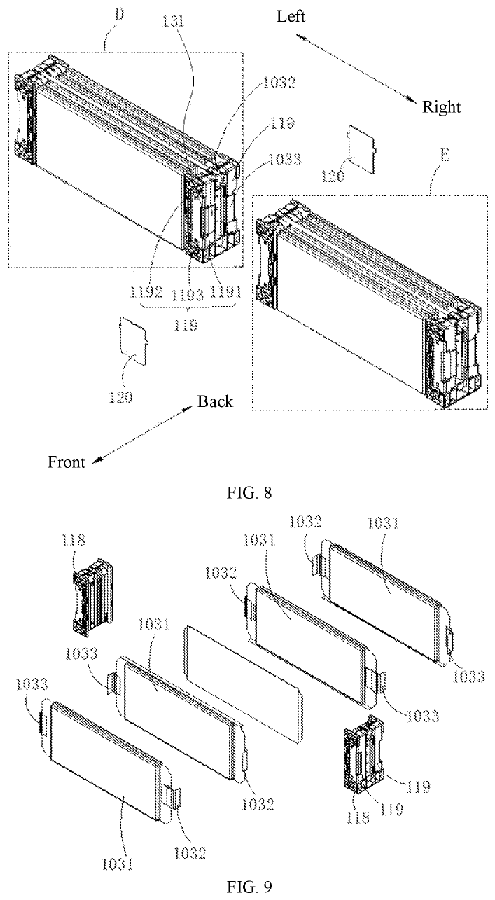

Further, as shown in FIG. 2, FIG. 7, and FIG. 8, two battery core groups 103 respectively of the first battery core string 115 and the second battery core string 116 that are right opposite to each other may correspond to the same first support 118. The first support 118 is provided with two conductive sheets 119 spaced apart. Each conductive sheet 119 is electrically connected with the corresponding battery core group 103. As shown in FIG. 8 to FIG. 9, along the direction from left to right, the two battery core groups 103 located at the left side correspond to a same first support 118 (e.g., the left first support). The two battery core groups 103 are arranged along the direction from front to back. The conductive sheets 119 on the first support 118 (e.g., the left first support) are electrically connected with the corresponding battery core groups 103 (e.g., the two battery core groups 103 located at the left side). Two battery core groups 103 located at the right side correspond to another first support 118 (e.g., the right first support). The two battery core groups 103 are arranged along the direction from front to back. The conductive sheets 119 on the first support 118 (e.g., the right first support) are electrically connected with the corresponding battery core groups 103 (e.g., the two battery core groups 103 located at the right side).

In some embodiments, as shown in FIG. 2 and FIG. 11, the two battery core groups 103 used for connecting the first battery core string 115 and the second battery core string 116 in series are respectively a first battery core group 121 and a second battery core group 122. The battery core unit 100 further includes a second support 124 for fixing a second connection sheet 123. The second support 124 is located at the first end 127 of the first battery core string 115. The positive tabs 1032 of the battery cores 1031 of one battery core group 103 of the first battery core group 121 and the second battery core group 122 and the negative tabs 1033 of the battery cores 1031 of the other battery core group 103 penetrate through the second support 124 and are electrically connected through the second connection sheet 123. As shown in FIG. 11, the negative tabs 1033 of the battery cores 1031 of the first battery core group 121 and the positive tabs 1032 of the battery cores 1031 of the second battery core group 122 penetrate through the second support 124 and are electrically connected through the second connection sheet 123. In an embodiment, it may also be that the positive tabs 1032 of the battery cores 1031 of the first battery core group 121 and the negative tabs 1033 of the battery cores 1031 of the second battery core group 122 penetrate through the second support 124 and are electrically connected through the second connection sheet 123.

In some embodiments, as shown in FIG. 2, FIG. 3, and FIG. 11, the sampling structure 102 is arranged on one side of the battery core string 101 along the third direction. The second connection sheet 123 includes a base body portion 1231 and an extension portion 1232. The base body portion 1231 is arranged/disposed on one side of the second support 124 deviating from the first battery core string 115. The base body portion 1231 is provided with a through hole 134. The negative tab 1033 of at least one battery core 1031 of the first battery core group 121 and the positive tab 1032 of at least one battery core 1031 of the second battery core group 122 penetrate through the through hole 134 and are electrically connected with two opposite sides of the base body portion 1231. In an embodiment, it may also be that the positive tab 1032 of at least one battery core 1031 of the first battery core group 121 and the negative tab 1033 of at least one battery core 1031 of the second battery core group 122 penetrate through the through hole 134 and are electrically connected with the two opposite sides of the base body portion 1231.

The extension portion 1232 is arranged/disposed at one end of the base body portion 1231 close to the sampling structure 102, and the extension portion 1232 is located on one side of the second support 124 along the third direction. The extension portion 1232 is configured to be electrically connected with the sampling structure 102. In an embodiment, the extension portion 1232 maybe connected with the first collection terminal 112. By disposing the extension portion 1232 on one side of the second support 124 along the third direction, the connection of the extension portion 1232 and the sampling structure 102 is facilitated.

In some embodiments, the second connection sheet 123 is fixed to the second support 124 through snap fit. In an embodiment, one side of the second support 124 deviating from the first battery core string 115 is provided with a snap-fit fastener, and the snap-fit fastener is configured to be in snap-fit with the base body portion 1231. In some embodiments, the second connection sheet 123 may also be fixed to the corresponding second support 124 in a threaded connection manner.

In some embodiments, as shown in FIG. 2 and FIG. 4, the battery core unit 100 further includes a third support 125. The third support 125 is located at the second end 128 of the first battery core string 115. Two third connection sheets 126 are arranged/disposed spaced apart on the third support 125. Two battery core groups 103 located at the second ends 128 of the first battery core string 115 and the second battery core string 116 are respectively a third battery core group 132 and a fourth battery core group 133. The positive tabs 1032 of the battery cores 1031 of one battery core group 103 from the third battery core group 132 and the fourth battery core group 133 penetrate through the third support 125 and are electrically connected through one of the third connection sheets 126, and the negative tabs 1033 of the battery cores 1031 of the other battery core group 103 from the third battery core group 132 and the fourth battery core group 133 penetrate through the third support 125 and are electrically connected through the other third connection sheet 126.

The structure of the third connection sheet 126 may be the same with the structure of the conductive sheet 119, which is not repeated herein.

According to another aspect, the present disclosure further provides a battery 1000, which includes a housing 200 and a battery core unit 100 according to any one of the above embodiments. The battery core unit 100 is arranged/disposed in the housing 200. According to the battery 1000 provided by the present disclosure, the sampling structure 102 can be arranged on the fixing support 104 through limiting fit of the limiting strips 107, so as to reduce shaking of the sampling structure 102, which is beneficial to improve connection reliability of the sampling structure 102 and the battery cores 1031.

According to another aspect, the present disclosure further provides a vehicle 2000, which includes an above battery 1000.

In the description of the present disclosure, it should be understood that orientation or position relationships indicated by the terms such as “center”, “longitudinal”, “transverse”, “length”, “width”, “thickness”, “up”, “down”, “front”, “back”, “left”, “right”, “vertical”, “horizontal”, “top”, “bottom”, “inside”, and “outside” are based on orientation or position relationships shown in the accompanying drawings, to facilitate the description of the present disclosure and simplify the description only, rather than indicating or implying that the mentioned apparatus or element must have a particular orientation or must be constructed and operated in a particular orientation. Therefore, such terms should not be construed as limiting of the present disclosure. In addition, a feature defined to be “first” and “second” may explicitly or implicitly include one or more features. In the description of the present disclosure, unless otherwise stated, “multiple” means two or more than two.

In the description of the present disclosure, it should be noted that, unless otherwise explicitly specified or defined, the terms such as “mount”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art may understand the meanings of the foregoing terms in the present disclosure according to situations.

In the descriptions of this specification, descriptions referring to terms “an embodiment”, “some embodiments”, “an exemplary embodiment”, “an example”, “a specific example”, or “some examples” mean that features, structures, materials, or characteristics described with reference to the embodiment or example are included in at least one embodiment or example of the present disclosure. In this specification, exemplary descriptions of the foregoing terms do not necessarily refer to the same embodiment or example. In addition, the described features, structures, materials, or characteristics may be combined in a proper manner in any one or more of the embodiments or examples.

Although the embodiments of the present disclosure have been shown and described, a person of ordinary skill in the art should understand that various changes, modifications, replacements and variations may be made to these embodiments without departing from the principles and spirit of the present disclosure, and the scope of the present disclosure is as defined by the appended claims and their equivalents.

What is claimed is:

1. A battery core unit, comprising: a battery core string and a sampling structure;
the battery core string comprising a plurality of battery core groups and at least one fixing support, the battery core groups being connected and disposed along a first direction, and two adjacent battery core groups being connected via a fixing support of the at least one fixing support;
the sampling structure being electrically connected with the battery core groups, the sampling structure comprising a notch, and the notch comprising a limiting strip; and
the fixing support comprising a first protrusion and a second protrusion, the first protrusion and the second protrusion being located in the notch and disposed spaced apart to form a spacing region, and the limiting strip being fitted in the spacing region.

2. The battery core unit according to claim 1, wherein an opening of the notch is located on a top surface of the sampling structure, the opening is extended along the first direction, the first protrusions and the second protrusions are disposed spaced apart along the first direction, and two opposite inner walls of the notch along a second direction are connected by the limiting strip.

3. The battery core unit according to claim 2, wherein the sampling structure comprises a plurality of collection terminals, each of the collection terminals is electrically connected with a corresponding battery core group, the collection terminals comprise a first collection terminal, second collection terminals, and third collection terminals, the first collection terminal and the second collection terminals are disposed at two opposite ends of the battery core string along the first direction, the third collection terminals are located between the first collection terminal and the second collection terminals, and the third collection terminals are disposed on the top surface of the sampling structure and located on the notch.

4. The battery core unit according to claim 3, wherein the battery core unit comprises at least two battery core strings including the battery core string, wherein
the at least two battery core strings are disposed along the second direction, each of the at least two battery core strings has a first end and a second end opposite to each other along the first direction, the at least two battery core strings comprise a first battery core string and a second battery core string, and the first battery core string and the second battery core string are connected through two first battery core groups respectively located at the first ends of the first battery core string and the second battery core string;
each of the first battery core string and the second battery core string comprises M battery core groups disposed along the first direction, and M is an integer greater than or equal to 2; the sampling structure comprises 2M+1 collection terminals that comprise one first collection terminal, two second collection terminals, and 2M−2 third collection terminals, the first collection terminal is disposed at the first ends of the first battery core string and the second battery core string, the two second collection terminals are respectively disposed at the second ends of the first battery core string and the second battery core string, and the two second collection terminals and the 2M−2 third collection terminals are extended in the second direction; and
the first battery core groups respectively located at the first ends are electrically connected with the first collection terminal, second battery core groups respectively located at the second ends are respectively electrically connected with the two second collection terminals, the 2M−2 third collection terminals comprise M−1 pairs of third collection terminals, each of the M−1 pairs of third collection terminals comprises two third collection terminals, and the two third collection terminals are located between two adjacent battery core groups respectively of the first battery core string and the second battery core string and are electrically connected with the two adjacent battery core groups of the first battery core string and the second battery core string.

5. The battery core unit according to claim 4, comprising two notches including the notch disposed in the second direction, and two first protrusions including the first protrusion and two second protrusions including the second protrusion; and
wherein for each of the two notches, the first protrusion and the second protrusion are disposed in the corresponding notch, and each of the two notches comprises the limiting strip, and the limiting strip fits in the corresponding spacing region.

6. The battery core unit according to claim 1, wherein the sampling structure is bonded and fixed to the fixing support.

7. The battery core unit according to claim 1, wherein
the two adjacent battery core groups are connected through a conductive connection member, and the fixing support is disposed between the two adjacent battery core groups and is configured to fix the conductive connection member;
each of the battery core groups comprises at least two battery cores connected in parallel, each of the at least two battery cores has a positive tab and a negative tab, and the positive tab and the negative tab are disposed at two opposite ends of each of the at least two battery cores along the first direction; and
a positive tab and a negative tab of two adjacent battery cores are connected through the conductive connection member.

8. The battery core unit according to claim 7, wherein
the fixing support comprises two first supports oppositely disposed along the first direction;
the conductive connection member comprises a first conductive sheet and a second conductive sheet respectively fixed to the two first supports; and
the positive tab of an adjacent battery core penetrates through a first one of the two first supports and is connected with the first conductive sheet, and the negative tab of the adjacent battery core penetrates through a second one of the first supports and is connected with the second conductive sheet.

9. The battery core unit according to claim 8, wherein
each of the first conductive sheet and the second conductive sheet comprises a body portion and a first bending portion;
body portions of the first conductive sheet and the second conductive sheet are respectively located on two opposite sides of the two first supports, and the body portions are configured to be electrically connected with the positive tab or the negative tab of the adjacent battery cores; and
the first bending portion is disposed at one end of the body portion close to the sampling structure, and is configured to be electrically connected with the sampling structure.

10. The battery core unit according to claim 9, wherein
each of the first conductive sheet and the second conductive sheet further comprises a second bending portion, the second bending portion is disposed on one side of the body portion opposite to the first bending portion, an avoidance opening is defined by the second bending portion and the body portion, and the avoidance opening is configured to accommodate the positive tab or the negative tab of the adjacent battery cores; and
the conductive connection member further comprises a first connection sheet, and the second bending portions of the first conductive sheet and the second conductive sheet are electrically connected through the first connection sheet.

11. The battery core unit according to claim 8, wherein the battery core unit comprises at least two battery core strings including the battery core string, wherein
the at least two battery core strings are disposed along a second direction, each of the at least two battery core strings has a first end and a second end opposite to each other along the first direction, the at least two battery core strings comprise a first battery core string and a second battery core string, and the first battery core string and the second battery core string are connected through two first battery core groups respectively located at the first ends; and
two adjacent battery core groups respectively in the first battery core string and the second battery core string correspond to a first support, the first conductive sheet and the second conductive sheet are disposed on the first support and are spaced apart, and each of the first conductive sheet and the second conductive sheet is electrically connected with the corresponding battery core group.

12. The battery core unit according to claim 11, wherein
the first battery core string and the second battery core string are connected in series by the adjacent battery core groups respectively of the first battery core string and of the second battery core string.

13. The battery core unit according to claim 11, further comprising a third support, wherein two third connection sheets are disposed on the third support and are spaced apart, the third support is located at the second end of the first battery core string, a seventh battery core group of the first battery core string and a eighth battery core group of the second battery core string are disposed at the second ends, the positive tabs of the battery cores of the seventh battery core group penetrate through the third support and are electrically connected through one of the two third connection sheets, and the negative tabs of the battery cores of the eighth battery core group penetrate through the third support and are electrically connected through the other one of the two third connection sheets.

14. A battery, comprising a housing and a battery core unit, the battery core unit disposed in the housing, wherein the battery core unit comprises:
the battery core string comprising a plurality of battery core groups and at least one fixing support, the battery core groups being connected and disposed along a first direction, and two adjacent battery core groups being connected via a fixing support of the at least one fixing support;
a sampling structure being electrically connected with the battery core groups, the sampling structure comprising a notch, and the notch comprising a limiting strip; and
the fixing support comprising a first protrusion and a second protrusion, the first protrusion and the second protrusion being located in the notch and disposed spaced apart to form a spacing region, and the limiting strip being fitted in the spacing region.

15. The battery according to claim 14, wherein an opening of the notch is located on a top surface of the sampling structure, the opening is extended along the first direction, the first protrusions and the second protrusions are disposed spaced apart along the first direction, and two opposite inner walls of the notch along a second direction are connected by the limiting strip.

16. The battery according to claim 15, wherein the sampling structure comprises a plurality of collection terminals, each of the collection terminals is electrically connected with a corresponding battery core group, the collection terminals comprise a first collection terminal, second collection terminals, and third collection terminals, the first collection terminal and the second collection terminals are disposed at two opposite ends of the battery core string along the first direction, and the third collection terminals are located between the first collection terminal and the second collection terminals, and the third collection terminals are disposed on the top surface of the sampling structure and located on the notch.

17. The battery according to claim 16, wherein the battery core unit comprises at least two battery core strings including the battery core string, wherein
the at least two battery core strings are disposed along the second direction, each of the at least two battery core strings has a first end and a second end opposite to each other along the first direction, the at least two battery core strings comprise a first battery core string and a second battery core string, and the first battery core string and the second battery core string are connected through two first battery core groups respectively located at the first ends of the first battery core string and the second battery core string;
each of the first battery core string and the second battery core string comprises M battery core groups disposed along the first direction, and M is an integer greater than or equal to 2; the sampling structure comprises 2M+1 collection terminals that comprise one first collection terminal, two second collection terminals, and 2M−2 third collection terminals, the first collection terminal is disposed at the first ends of the first battery core string and the second battery core string, the two second collection terminals are respectively disposed at the second ends of the first battery core string and the second battery core string, the two second collection terminals and the 2M−2 third collection terminals are extended in the second direction; and
the first battery core groups respectively located at the first ends are electrically connected with the first collection terminal, second battery core groups respectively located at the second ends are respectively electrically connected with the two second collection terminals, the 2M−2 third collection terminals comprise M−1 pairs of third collection terminals, each of the M−1 pairs of third collection terminals comprises two third collection terminals, and the two third collection terminals are located between two adjacent battery core groups respectively of the first battery core string and the second battery core string and are electrically connected with the two adjacent battery core groups of the first battery core string and the second battery core string.

18. The battery according to claim 14, wherein the sampling structure is bonded and fixed to the fixing support.

19. The battery according to claim 14, wherein
the two adjacent battery core groups are connected through a conductive connection member, and the fixing support is disposed between the two adjacent battery core groups and is configured to fix the conductive connection member;
each of the battery core groups comprises at least two battery cores connected in parallel, each of the at least two battery cores has a positive tab and a negative tab, and the positive tab and the negative tab are disposed at two opposite ends of each of the at least two battery cores along the first direction; and
a positive tab and a negative tab of the two adjacent battery cores are connected through the conductive connection member.

20. A vehicle, comprising a battery, the battery comprising a housing and a battery core unit, the battery core unit disposed in the housing, wherein the battery core unit comprises:
the battery core string comprising a plurality of battery core groups and at least one fixing support, the battery core groups being connected and disposed along a first direction, and two adjacent battery core groups being connected via a fixing support of the at least one fixing support;
a sampling structure being electrically connected with the battery core groups, the sampling structure comprising a notch, and the notch comprising a limiting strip; and
the fixing support comprising a first protrusion and a second protrusion, the first protrusion and the second protrusion being located in the notch and disposed spaced apart to form a spacing region, and the limiting strip being fitted in the spacing region.
